(19) United States
(12) Patent Application Publication
(10) Pub. No.: US 2011/0310288 A1
(43) Pub. Date: Dec. 22, 2011

(54) METHOD OF DETERMINING AUTO-FOCUSING FAILURE

(75) Inventor: Hyung Keun LEE, Suwon (KR)

(73) Assignee: SAMSUNG ELECTRO-MECHANICS CO., LTD.

(21) Appl. No.: 13/162,116

(22) Filed: Jun. 16, 2011

(30) Foreign Application Priority Data
Jun. 16, 2010 (KR) 10-2010-0057049

(51) Int. Cl. H04N 5/232

(52) U.S. Cl. 348/345; 348/E05.045

(57) ABSTRACT

There is provided a method of determining an auto-focusing failure in which the auto-focusing failure may be rapidly determined even in the case that a lens moving for auto-focusing does not detect auto-focusing evaluation values while moving along the entire moving distance. The method includes: sequentially moving a position of a lens for auto-focusing in a plurality of continuous steps; calculating and storing an auto-focusing evaluation value for each of positions to which the lens moves; comparing an auto-focusing evaluation value calculated at a position to which the lens moves with an auto-focusing evaluation value calculated at a previous step to thereby determine whether the auto-focusing evaluation value has increased or decreased; and determining that auto-focusing has failed when the auto-focusing evaluation value changes from an increased state to a decreased state or from a decreased state to an increased state.

### CROSS-REFERENCE TO RELATED APPLICATIONS

This application claims the priority of Korean Patent Application No. 10-2010-0057049 filed on Jun. 16, 2010, in the Korean Intellectual Property Office, the disclosure of which is incorporated herein by reference.

### BACKGROUND OF THE INVENTION

1. Field of the Invention

The present invention relates to a method of determining an auto-focusing failure, and more particularly, to a method of determining an auto-focusing failure in which the auto-focusing failure maybe rapidly determined even in the case that a lens moving for auto-focusing does not detect auto-focusing evaluation values while moving along the entire moving distance.

2. Description of the Related Art

Recently, small, mobile electronic devices such as a cellular phone, a personal digital assistance (PDA), or the like, including a display unit, have a digital camera function embedded thereon. In accordance with the rapid progress of technologies associated with a lens, an image sensor, an image processing processor, or the like, used in a camera module included in these small, mobile electronic devices, there is a trend towards applying advanced photography functions included in a general digital still camera to a small camera module.

As one of these functions, there is provided an auto-focusing function, auto-focusing a subject to be photographed. This auto-focusing function may be performed by calculating auto-focusing evaluation values of images formed by photographing a subject at various lens positions while moving a lens in preset steps, detecting peaks of these auto-focusing evaluation values, and determining that positions of the lens in which the peaks appear are focused lens positions.

The auto-focusing evaluation values for auto-focusing may become filtered values obtained by applying a high pass filter detecting edge components to at least a portion of images captured at lens positions at each step. Therefore, in the case of performing auto-focusing using an image having clear edges or a partial region of the image, precise peaks of auto-focusing evaluation values are calculated to find a position of the lens having a maximum auto-focusing evaluation value, whereby auto-focusing may be successfully completed.

However, in the case of an image that does not have clearly distinguished edges, such as a bright sky or a monochrome wall surface, peaks do not appear in filtered values obtained by applying the high pass filter to the image. Therefore, after a lens moving for auto-focusing moves over the entire moving distance, the lens determines that it has not found peak values, and determines that auto-focusing has failed.

As described above, in the case of an auto-focusing scheme according to the related art, in order to determine an auto-focusing failure, with respect to an image that does not have clearly distinguished edges such as a bright sky or monochrome wall surface, a process of calculating auto-focusing evaluation values while moving the lens over the entire moving distance needs to be performed. Therefore, determining an auto-focusing failure may take an excessive amount of time and power consumption due to unnecessary lens movement may be generated.

### SUMMARY OF THE INVENTION

An aspect of the present invention provides a method of determining an auto-focusing failure in which the auto-focusing failure may be rapidly determined even in the case that a lens moving for auto-focusing does not detect auto-focusing evaluation values while moving along the entire moving distance.

According to an aspect of the present invention, there is provided a method of determining an auto-focusing failure, the method including: sequentially moving a position of a lens for auto-focusing in a plurality of continuous steps; calculating and storing an auto-focusing evaluation value for each of positions to which the lens moves; comparing an auto-focusing evaluation value calculated at a position to which the lens moves with an auto-focusing evaluation value calculated at a previous step to thereby determine whether the auto-focusing evaluation value has increased or decreased; and determining that auto-focusing has failed when the auto-focusing evaluation value changes from an increased state to a decreased state or from a decreased state to an increased state.

The sequential moving may include moving the lens from one distal end of the entire moving distance over which the lens moves for auto-focusing to another distal end thereof.

The determining that auto-focusing has failed may include determining that auto-focusing has failed when the number of changes of the auto-focusing evaluation value from the increased state to the decreased state or from the decreased state to the increased state is at least two or more.

The calculating and storing of the auto-focusing evaluation value may include obtaining an image for each of the steps to which the lens moves and using a filtered value calculated by applying a high pass filter to at least a portion of the image as the auto-focusing evaluation value.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view schematically showing the configuration of a camera module to which a method of determining an auto-focusing failure according to an embodiment of the present invention is applied;

FIG. 2 is a flow-chart showing a method of determining an auto-focusing failure according to an embodiment of the present invention; and

FIGS. 3A and 3B are graphs showing examples of increases or decreases in auto-focusing evaluation values used in a method of determining an auto-focusing failure according to an embodiment of the present invention.

### DETAILED DESCRIPTION OF THE PREFERRED EMBODIMENT

Embodiments of the present invention will be described with reference to the accompanying drawings. The embodiments of the present invention maybe modified in many different forms and the scope of the invention should not be limited to the embodiments set forth herein. Rather, these embodiments are provided so that this disclosure will be thorough and complete, and will fully convey the concept of the invention to those skilled in the art.

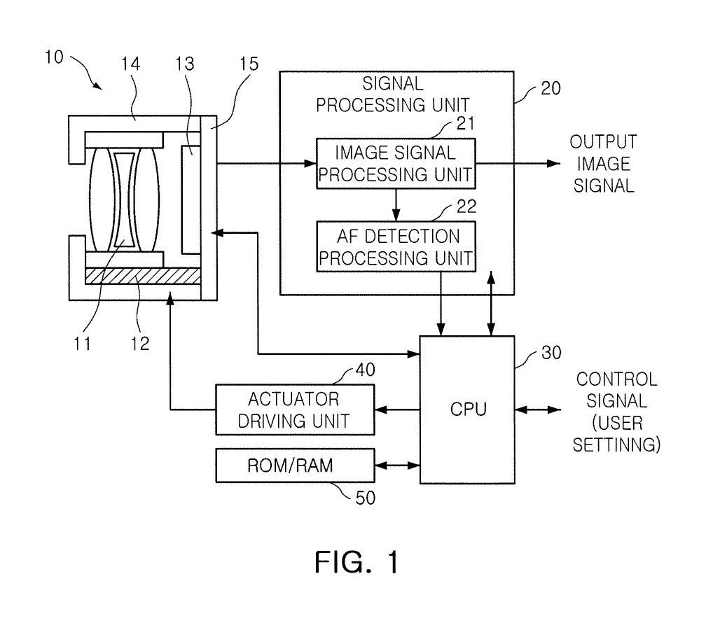

FIG. 1 is a view schematically showing the configuration of a camera module to which a method of determining an auto-focusing failure according to an embodiment of the present invention is applied.

Referring to FIG. 1, a camera module, to which a method of determining an auto-focusing failure according to an embodiment of the present invention is applied, may include a lens unit 10 including a lens 11 moving for auto-focusing and an image sensor 13 detecting light input through the lens, a signal processing unit 20 processing an image detected by the image sensor 13 and calculating auto-focusing evaluation values for auto-focusing, a central processing unit (CPU) 30 generating a command for moving the lens according to a control signal by a user and the auto-focusing evaluation values, an actuator driving unit 40 driving an actuator providing physical force for moving the lens 11 according to the command for moving the lens, and a read only memory/random access memory (ROM/RAM) 50 storing various information required for driving a camera therein.

The lens unit 10 may further include a plurality of lenses 11 imaging a subject on the image sensor 13, a barrel 14 providing a path through which the lens 11 moves at the time of an auto-focusing operation, a circuit board 15 having the image sensor 13 mounted thereon, and an actuator 12 providing physical force so that the lens 11 may move along the barrel 14 by a predetermined moving amount. The image sensor 13 may be a complementary metal oxide semiconductor (CMOS) sensor or a charge coupled device (CCD) sensor and may convert the image imaged by the lens into an electrical image signal. The actuator 12 needs to be capable of precisely controlling a distance of a single movement of the lens 11, that is, a single step. To this end, a stepping motor, a voltage controlled actuator (VCA), a piezoactuator, or the like, may be used as the actuator 12.

The signal processing unit 20 may include an image signal processing unit 21 performing image processing such as color processing, definition processing, or the like, on the electrical image signal output from the image sensor 13 and an auto-focusing (AF) detection processing unit 22 calculating the auto-focusing evaluation values for auto-focusing from an image signal received from the image signal processing unit 21. The AF detection processing unit 22 may use filtered values calculated by applying a high pass filter to at least a portion of the image signal as the auto-focusing evaluation values.

The CPU 30 controls an operation of the image sensor 13, the signal processing unit 20, or the actuator driving unit 40 according to a control signal (a user input) input from the outside to thereby control the entire camera module.

The actuator driving unit 40 drives the actuator 12 for moving the lens 11 according to a control command of the CPU 30.

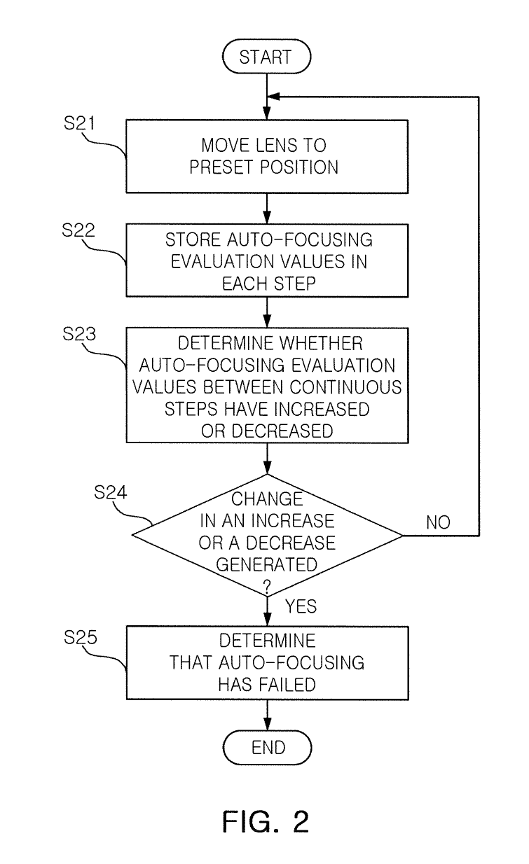

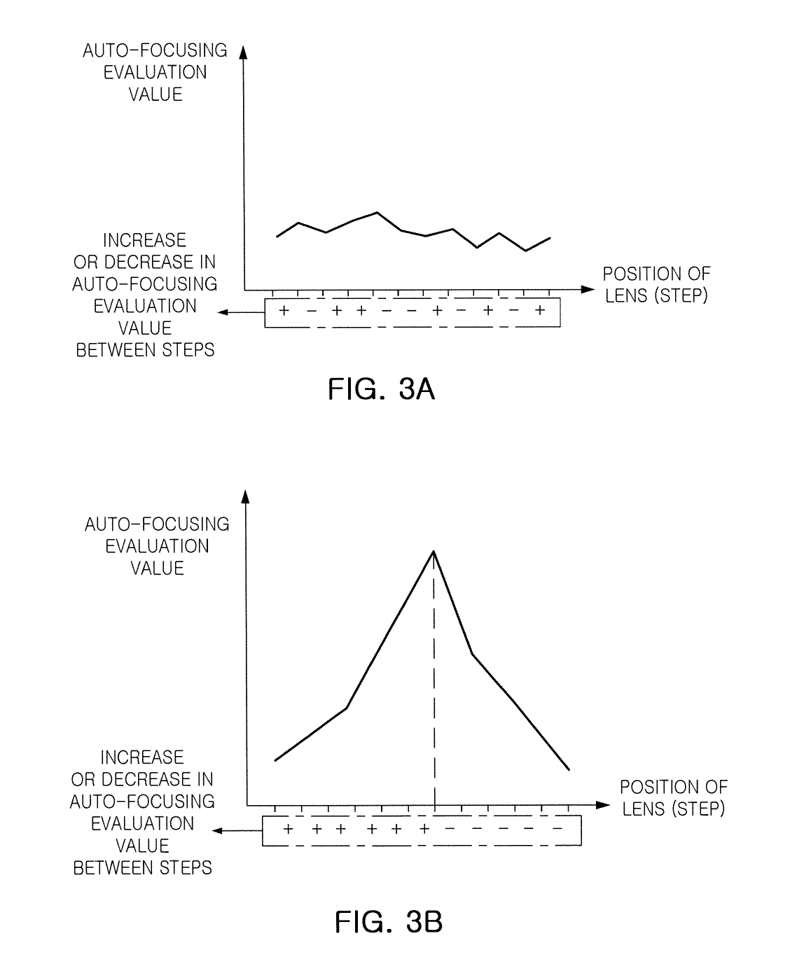

FIG. 2 is a flow-chart showing a method of determining an auto-focusing failure according to an embodiment of the present invention; and FIGS. 3A and 3B are graphs showing examples of increases or decreases in auto-focusing evaluation values used in a method of determining an auto-focusing failure according to an embodiment of the present invention.

Hereinafter, the operation and effect of a method of determining an auto-focusing failure according to an embodiment of the present invention will be described in detail with reference to the accompanying drawings.

When auto-focusing starts, the lens 11 moves to preset positions within the barrel 14 (S21) and obtains images at positions corresponding to individual steps.

The lens 11 moves to the preset positions by the actuator during the progression of the auto-focusing. When auto-focusing starts, the lens 11 may move to a distal end of the entire moving distance for auto-focusing, and then move from the distal end to the preset positions. That is, the lens 11 may start a movement for auto-focusing from a position closest to or farthest from the image sensor 13 among a range of movement thereof.

Then, images are obtained by the image sensor 13 at each of the positions to which the lens 11 moves, and auto-focusing evaluation values are calculated and stored by using the entirety or at least a portion of the obtained images (S22).

When the lens 11 moves to a predetermined position and is disposed therein, the image sensor 13 detects an image imaged by light penetrating through the lens 11, and the detected image signal is appropriately processed in the image signal processing unit 21. The images output from the image signal processing unit 21 are transferred to the AF detection processing unit 22, and the AF detection processing unit 22 calculates the auto-focusing evaluation values by using the entirety or at least a portion of the transferred images.

The AF detection processing unit 22 may calculate the auto-focusing evaluation values by various methods known in the art. The AF detection processing unit 22 may use filtered values obtained by applying the high pass filter to at least a portion of the images as the auto-focusing evaluation values.

When the high pass filter is applied to the image signal, only edge components existing in the image remain. When the focusing is accurately performed in the same image, the edge components are further increased. Therefore, the filtered values obtained by applying the high pass filter may be used as the auto-focusing evaluation values.

The auto-focusing evaluation values output by the AF detection processing unit 22 may be stored in a storage unit such as the ROM/RAM 50 by the CPU 30 in real time.

Then, the auto-focusing evaluation values stored in the storage unit such as the ROM/RAM 50 are compared with the auto-focusing evaluation values stored at a previous step in real time, such that it is determined whether they are increased or decreased (S23). This operation may be performed under the control of the CPU 30. That is, when auto-focusing evaluation values are calculated and stored at a current position of the lens 11 by the AF detection processing unit 22, the CPU 30 compares the auto-focusing evaluation values calculated and stored at the current position of the lens 11 with auto-focusing evaluation values calculated and stored at a position of the lens 11 immediately before the current position of the lens 11 to thereby determine whether the auto-focusing evaluation values have increased or decreased.

Then, whether or not the auto-focusing evaluation values change from an increased state to a decreased state or from a decreased state to an increased state is confirmed (S24), and it is determined that auto-focusing has failed when a change in an increased or a decreased state in the auto-focusing evaluation values is generated (S25). A basis of this determination will be described in detail with reference to FIGS. 3A and 3B.

FIGS. 3A and 3B are graphs showing examples of increases or decreases in auto-focusing evaluation values used in a method of determining an auto-focusing failure according to an embodiment of the present invention.

In the case of performing auto-focusing with respect to an image such as a bright sky or a monochrome wall surface that does not almost have edges, the auto-focusing evaluation value has a shape in which an increase or a decrease having a narrow range is repeated while having no peak, as shown in FIG.

3A. Therefore, in the case of the image having the auto-focusing evaluation value as shown in FIG. 3A, even when the lens moves along the entire moving distance, auto-focusing is not completed.

On the other hand, in the case of performing auto-focusing with respect to an image that has clear edges, a definite peak appears at a position of the lens at which an image having the clearest edge is photographed, as shown in FIG. 3B. Therefore, a section in which the auto-focusing evaluation value is constantly increased and a section in which the auto-focusing evaluation value is constantly decreased are continuously generated.

Therefore, according to an embodiment of the present invention, in order to rapidly determine an auto-focusing failure with respect to the image having the auto-focusing evaluation values as shown in FIG. 3A, the auto-focusing evaluation values calculated at positions of the lens corresponding to the respective steps are compared with the auto-focusing evaluation values calculated at positions of the lens in previous steps to thereby determine whether the auto-focusing evaluation values have increased or decreased (S23). Then, when a change in an increase or a decrease in the auto-focusing evaluation values is generated (S24), that is, when the auto-focusing evaluation values have increased and then decreased or have decreased and then increased (S24), it is determined that the image is an image for which auto-focusing may not be performed and is also determined at an early stage that auto-focusing has failed, as shown in FIG. 3A (S25).

Most simply, when the auto-focusing evaluation values are calculated at the positions of the lens at three steps after auto-focusing is performed, it may be twice determined whether the auto-focusing evaluation values have increased or decreased. However, as shown in FIG. 3A, even in the case of the image for which auto-focusing may not be performed, a section in which the auto-focusing evaluation values have increased or decreased may be repeated two times or more. In addition, as shown in FIG. 3B, a section in which the increase or decrease of the auto-focusing evaluation values changes may be generated before and after the peak appears. Therefore, according to the embodiment of the present invention, when the number of changes of the auto-focusing evaluation values from an increased state to a decreased state or from a decreased state to an increased state is at least two, it may be determined that auto-focusing has failed.

As set forth above, according to embodiments of the present invention, an auto-focusing failure may be rapidly determined at an early stage of auto-focusing, without allowing a lens moving for auto-focusing to detect auto-focusing evaluation values while moving along the entire moving distance.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of determining an auto-focusing failure, the method comprising:
sequentially moving a position of a lens for auto-focusing in a plurality of continuous steps;
calculating and storing an auto-focusing evaluation value for each of positions to which the lens moves;
comparing an auto-focusing evaluation value calculated at a position to which the lens moves with an auto-focusing evaluation value calculated at a previous step to thereby determine whether the auto-focusing evaluation value has increased or decreased; and
determining that auto-focusing has failed when the auto-focusing evaluation value changes from an increased state to a decreased state or from a decreased state to an increased state.

2. The method of claim 1, wherein the sequential moving includes moving the lens from one distal end of the entire moving distance over which the lens moves for auto-focusing to another distal end thereof.

3. The method of claim 1, wherein the determining that auto-focusing has failed includes determining that auto-focusing has failed when the number of changes of the auto-focusing evaluation value from the increased state to the decreased state or from the decreased state to the increased state is at least two or more.

4. The method of claim 1, wherein the calculating and storing of the auto-focusing evaluation value includes obtaining an image for each of the steps to which the lens moves and using a filtered value calculated by applying a high pass filter to at least a portion of the image as the auto-focusing evaluation value.
